(19) United States
(12) Patent Application Publication
(10) Pub. No.: US 2012/0085661 A1
(43) Pub. Date: Apr. 12, 2012

(54) POUCH TYPE FOOD PAD AND FOOD TRAY

(75) Inventor: Goran Eriksson, Karlstad (SE)

(73) Assignee: CELLCOMB AB, Karstad (SE)

(21) Appl. No.: 13/251,824

(22) Filed: Oct. 3, 2011

Related U.S. Application Data
(60) Provisional application No. 61/392,064, filed on Oct. 12, 2010.

(51) Int. Cl. B65D 81/26; B32B 1/04

(52) U.S. Cl. 206/204; 428/76

(57) ABSTRACT

This invention relates to a pouch-type food pad for use in a food tray to absorb and withhold liquid, comprising an absorbing kernel (11) enclosed in a pouch (10, 12) formed by a first layer (10) and a second layer (12) adjoined by a bond (13), wherein that said absorbing kernel (11) is in the form of a SAP/SAF free airlaid high absorbing material and that said first layer (10) is in the form of a breathable biodegradable film.

This application claims domestic priority under 35 U.S.C. 120 to U.S. provisional patent app'n Ser. No. 61/392,064, filed 12 Oct. 2010, the complete disclosure of which is incorporated herein by reference.

### TECHNICAL FIELD

This invention relates to a pouch-type food pad for using a food tray to absorb and withhold liquid, comprising an absorbing kernel enclosed in a pouch formed by a first layer and a second layer adjoined by a bond.

### BACKGROUND

Food trays with high absorbing pads are commonly used for improving on storage life and freshness of different food products, such as meat, poultry, fish and fruit, by using the food pad to absorb superfluous liquid. There exist many different types of food pads, e.g. single sheet laminated type food pads and pouch type food pads. Pouch-type food pads have the advantage that they eliminate the risk of absorbing material to stick to food product. This is achieved by means of using a permeable material in the pouch, comprising a first and a second layer that are bonded together around a kernel of absorbing material, wherein the layer in contact with the food product is permeable and also resistant to moisture/liquid, thereby eliminating any parts of the pads to stick to the food product. Mostly some kind of superabsorbent (SAP) or superabsorbent fiber (SAF), often in connection with some kind of binder, is being used as the main material in such a pouch-type food pad. The use of food pads has been well accepted by the markets. However, still there is a desire that the storage of food products could be performed with even longer storage life and appearance of freshness.

### SUMMARY OF THE INVENTION

It is an object of the invention to further improve on storage life and appearance of food freshness, which is achieved by means of pouch-type food pad according to the independent claim.

It has surprisingly been found that by the use of a pouch-type food pad according to the invention may provide a drastic prolongation of storage life and appearance of freshness.

According to a further aspect to the invention the first layer has a thickness of 8μ-50μ, preferably 10μ-30μ, and preferably providing a permeability of more than 100 ml/m² 24 h, preferably at least 200 ml/m² 24 h.

According to a further aspect to the invention is that the thickness of said kernel corresponds to relative thickness ΔT/100 g/m² of between 0.1-0.5 mm, preferably 0.2-0.4 mm.

According to a further aspect to the invention the whole food pad is made from materials that are biodegradable, preferably completely compostable.

According to a further aspect to the invention is that said food tray is made in a biodegradable material, preferably PLA.

### BRIEF DESCRIPTION OF THE DRAWINGS

In the following the invention will be described more in detail with reference to the annexed drawing, wherein;

FIG. 1 shows a food tray containing a pouch-type food pad, and

FIG. 2 shows a schematic perspective view of a pouch-type food pad according to the invention.

### DETAILED DESCRIPTION

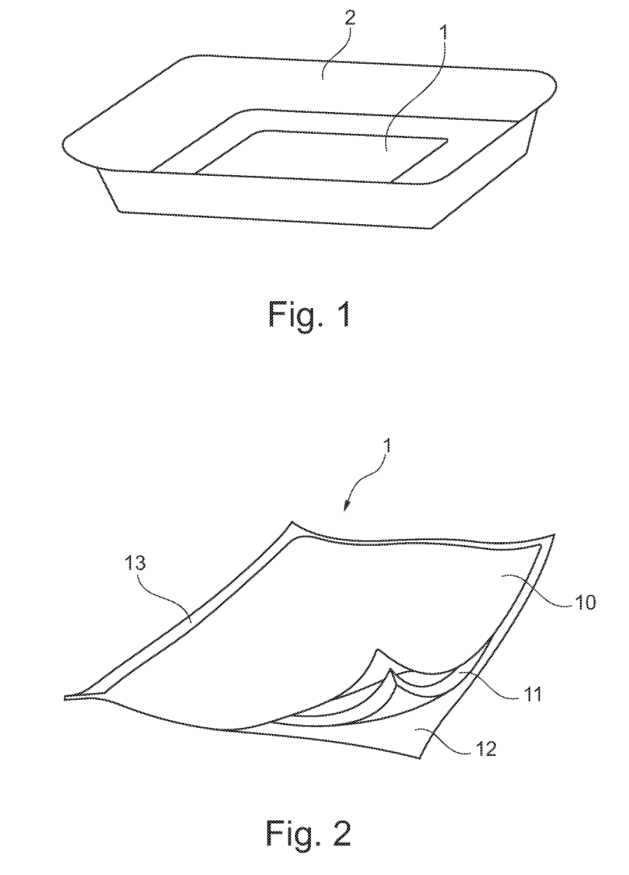

In FIG. 1 there is shown a food tray 2 of well known kind, preferably made in a compostable material, such as PLA. On the bottom within the food tray 2 there is positioned a pouch-type food pad 1 according to the invention.

In FIG. 2 there is shown a pouch-type food pad 1 according to the invention, having a first layer 10 and a bottom layer 12 and a kernel 11. The first and the second layers 10, 12 are adjoined at their edges by means of bond 13, which preferably is continuous. Within the space formed by the pouch 10, 12, 13 there is positioned a kernel 11 of a high absorbing material. The high absorbing material 11 is of a kind that does not contain any substantial amounts of superabsorbent polymers (SAP) or superabsorbent fibers (SAF). Nor does the kernel 11 comprise any substantial amount of binding material. Instead the kernel 11 comprises natural fibers, preferably containing at least 80% more preferred 100% of raw material fibers. The kernel is preferably produced in accordance with a method being used by SCA for their product LUNA (which is a trademark owned by SCA) or a method providing similar properties, e.g. described for example in WO99/33420A1. Another possible method which avoids the usage of any binders or thermal bonding can be found in EP0833977B1. The grammage of the absorbing kernel 11 is between 50-1000 g/m², preferably 100-800 g/m². The kernel is produced in connection with compressing it, e.g. between rolls arranged with an appropriate pattern, to a thickness of between 0.1-0.5 mm for a sheet kernel 11 of 100 g/m² preferably 0.2-0.4 mm for a sheet kernel 11 of 100 g/m². Thanks to the relatively small thickness there are considerable benefits gained in a logistic chain in connection with the use of pouch-type food pads, compared to prior art pads which normally have a thickness of 1 mm or more for a sheet kernel of 100 g/m².

The first layer 10 is a biodegradable film of thickness of 8μ-50μ, preferably 10μ-30μ. The biodegradable film may be a starch based film or made from PLA. The water vapor transmission rate of the first layer 10 is at least 100 ml/m² 24 h, preferably 200 ml/m² 24 h or more.

The second layer 12 may be made in the same material as the first layer 10 or in a different alternative materials and still fulfill the basic function of the invention. However in the preferred mode the whole pouch-type food pad should be totally compostable (fulfil the requirements of EN13432) and for such embodiments there exist different preferred possibilities, e.g. either a PLA non woven or a perforated biodegradable film. If the second layer is in a form of a PLA non woven material it may have a grammage of 8-50 g/m², preferably 10-40 g/m². It may be beneficial to laminate the PLA non woven with a starch film (not shown). The second layer 12 may be perforated in order to safe guard a high degree of permeability to liquid, especially in an alternative where the second layer 12 is in a form of a perforated biofilm of the same kind as being used in the first layer 10.

Thanks to the invention an environmentally friendly food package may be achieved that provides surprising advantages compared to non prior art food packages. It is shown that the use of pouch-type food pad 1 according to the invention in a food tray 2 for storing of meat may prolong the storage life and appearance of freshness by one day or more, i.e. more than 50%, in some situations.

1. A pouch-type food pad constructed for use in a food tray to absorb and withhold liquid comprising:
an absorbing kernel enclosed in a pouch formed by a first layer and a second layer adjoined by a bond, wherein said absorbing kernel is in the form of a SAP/SAF free airlaid high absorbing material and that said first layer is in the form of a breathable biodegradable film.

2. The pouch-type food pad according to claim 1, wherein said first layer has a thickness of 8μ-50μ.

3. The pouch-type food pad according to claim 1, wherein said first layer has a thickness of 10μ-20μ.

4. The pouch-type food pad according to claim 1, wherein said first layer has permeability of more than 100 ml/m² 24 h.

5. The pouch-type food pad according to claim 1, wherein said first layer has permeability of at least 200 ml/m² 24 h.

6. The pouch-type food pad according to claim 1, wherein the thickness (t) of said kernel corresponds to relative thickness ΔT/100 g/m² of between 0.1-0.5 mm

7. The pouch-type food pad according to claim 1, wherein the thickness (t) of said kernel corresponds to relative thickness ΔT/100 g/m² of between 0.2-0.4 mm

8. The pouch-type food pad according to claim 1, wherein the whole food pad is made from materials that are completely compostable.

9. The pouch-type food pad according to claim 8, wherein said second layer comprises a PLA nonwoven layer.

10. The pouch-type food pad according to claim 9, wherein said PLA nonwoven layer is laminated with starch film.

11. The pouch-type food pad according to claim 10, wherein the second layer has a grammage between 8-50 g/m².

12. The pouch-type food pad according to claim 10, wherein the second layer has a grammage between 10-30 g/m².

13. The pouch-type food pad according to claim 9, wherein the second layer is in a form of a biodegradable film of a thickness of 10-50μ.

14. The pouch-type food pad according to claim 13, wherein the second layer is perforated.

15. A food tray comprising:
a pouch-type food pad constructed to absorb and withhold liquid, wherein said pouch-type food pad comprises:
an absorbing kernel enclosed in a pouch formed by a first layer and a second layer adjoined by a bond, wherein said absorbing kernel is in the form of a SAP/SAF free airlaid high absorbing material and that said first layer is in the form of a breathable biodegradable film, and wherein said food tray is made in a biodegradable material.

16. The food tray according to claim 16, wherein the biodegradable material is PLA.
